(19) United States
(12) Patent Application Publication
(10) Pub. No.: US 2018/0046037 A1
(43) Pub. Date: Feb. 15, 2018

(54) MANUFACTURING METHOD OF ALIGNMENT FLIM AND DEVICE FOR MANUFACTURING ALIGNMENT FILM

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Haiyun LIN, Beijing (CN); Jingpeng LI, Beijing (CN); Yuekai GAO, Beijing (CN); Zhenyu XIE, Beijing (CN); Tae Yup MIN, Beijing (CN)

(21) Appl. No.: 15/535,218

(22) PCT Filed: Nov. 9, 2016
(86) PCT No.: PCT/CN2016/105211

§ 371 Date: Jun. 12, 2017

(30) Foreign Application Priority Data
Mar. 29, 2016 (CN) 201610188179.7

(51) Int. Cl. G02F 1/1337; B08B 7/00

(52) U.S. Cl. CPC G02F 1/133788; G02F 1/133723; B08B 7/0057; G02F 2001/1316

(57) ABSTRACT

A manufacturing method of an alignment film and a device for manufacturing an alignment film are provided, and the manufacturing method of the alignment film includes: irradiating a substrate with excimer ultraviolet (EUV) light; performing a cleaning process on the substrate which has been irradiated by the EUV light; and forming an alignment film on the substrate which has been performed the cleaning process. A substrate is irradiated with EUV light before performing a cleaning process on the substrate, and the organic contaminants which are difficult to be washed off on the surface of the substrate can be decomposed by the irradiating of the EUV light, therefore the coating defect is reduced.

### TECHNICAL FIELD

Embodiments of the present disclosure relate to a manufacturing method of an alignment film and a device for manufacturing an alignment film.

### BACKGROUND

With the increasingly development of display technology, because liquid crystal display devices have advantages of low power consumption, no radiation and so on, the liquid crystal display devices have occupied the dominant position in the field of flat panel display.

At present, the liquid crystal display panel in a liquid crystal display device mainly comprises an array substrate and a color filter substrate, which are arranged opposite to each other, and a liquid crystal layer which is filled between the array substrate and the color filter substrate, alignment films are arranged on both sides of the liquid crystal layer, and the alignment films are configured to make the liquid crystal molecules in the liquid crystal layer to be oriented to realize a display function.

### SUMMARY

At least one embodiment of the present disclosure provides a manufacturing method of an alignment film and a device for manufacturing an alignment film, the manufacturing method of an alignment film is capable of reducing the coating defects in the process of coating alignment liquid and improving the quality of the alignment film.

At least one embodiment of the present disclosure provides a manufacturing method of an alignment film, and the manufacturing method comprises: irradiating a substrate with excimer ultraviolet (EUV) light; performing a cleaning process on the substrate which has been irradiated by the EUV light; and forming the alignment film on the substrate which has been performed the cleaning process.

For example, in the manufacturing method of an alignment film provided in one embodiment of the present disclosure, the cleaning process comprises at least one cleaning procedure, and each cleaning procedure comprises: cleaning the substrate by a rolling brush; washing the substrate by gas-liquid mixture; and drying the substrate.

For example, in the manufacturing method of an alignment film provided in one embodiment of the present disclosure, at least three cleaning procedures are performed in the cleaning process.

For example, in the manufacturing method of an alignment film provided in one embodiment of the present disclosure, drying the substrate comprises: blowing the substrate by an air knife; and irradiating the substrate with far infrared light.

For example, in the manufacturing method of an alignment film provided in one embodiment of the present disclosure, before irradiating the substrate with excimer ultraviolet (EUV) light, the method further comprises: detecting standing time of the substrate, in a case that the standing time of the substrate is greater than or equal to a preset time period, the substrate is irradiated by the EUV light.

For example, in the manufacturing method of an alignment film provided in one embodiment of the present disclosure, the preset time period comprises six months.

For example, in the manufacturing method of an alignment film provided in one embodiment of the present disclosure, the amount of the EUV light is from 8000 mj/cm² to 9000 mj/cm².

For example, the manufacturing method of an alignment film provided in one embodiment of the present disclosure further comprises: coating alignment liquid on the substrate which has been subjected to the cleaning process; and curing the alignment liquid coated on the substrate to form the alignment film.

For example, in the manufacturing method of an alignment film provided in one embodiment of the present disclosure, a material of the alignment liquid comprises polyimide.

For example, in the manufacturing method of an alignment film provided in one embodiment of the present disclosure, the substrate comprises a color filter substrate or an array substrate.

At least one embodiment of the present disclosure provides a device for manufacturing an alignment film, and the device for manufacturing an alignment film comprises: an illumination device, configured to perform excimer ultraviolet (EUV) illumination on a substrate to form the alignment film; a cleaning device, configured to perform a cleaning process on the substrate; and an alignment film forming device, configured to form an alignment film on the substrate.

For example, in the device for manufacturing an alignment film provided in one embodiment of the present disclosure, the alignment film forming device comprises a coating device, configured to coat alignment liquid on the substrate which has been cleaned by the cleaning process; and a curing device, configured to cure the alignment liquid coated on the substrate to form the alignment film.

For example, in the device for manufacturing an alignment film provided in one embodiment of the present disclosure, the cleaning process comprises at least one cleaning procedure, and each cleaning procedure comprises: cleaning the substrate by a rolling brush; washing the substrate by gas-liquid mixture; and drying the substrate.

For example, the device for manufacturing an alignment film provided in one embodiment of the present disclosure further comprises: a detection device, configured to detect standing time of the substrate; and a control device, wherein the control device is configured to control the illumination device to irradiate the substrate by the EUV light in a case that the standing time of the substrate is greater than or equal to a preset time period.

For example, the device for manufacturing an alignment film provided in one embodiment of the present disclosure further comprises: a transmission device, configured to transmit the substrate to an illumination region corresponding to the illumination device, a cleaning region corresponding to the cleaning device, a coating region corresponding to the coating device and a curing region corresponding to a curing device successively.

For example, in the device for manufacturing an alignment film provided in one embodiment of the present disclosure, the control device is in communication with the transmission device, the illumination device, the cleaning device, the coating device and the curing device respectively; in a case that the standing time of the substrate is greater than or equal to the preset time period, after the transmission device transmits the substrate to the illumination region, the control device is configured to control the illumination device to irradiate the substrate by the EUV light; after the transmission device transmits the substrate to the cleaning region, the control device is configured to control the cleaning device to perform at least one cleaning procedure on the substrate; after the transmission device transmits the substrate to the coating region, the control device is configured to control the coating device to coat alignment liquid on the substrate; after the transmission device transmits the substrate to the curing region, the control device is configured to control the curing device to cure the alignment liquid on the substrate.

For example, in the device for manufacturing an alignment film provided in one embodiment of the present disclosure, the amount of the EUV light that the illumination device irradiates the substrate is from 8000 mj/cm² to 9000 mj/cm².

For example, in the device for manufacturing an alignment film provided in one embodiment of the present disclosure, an irradiation power of the illumination device to the substrate is greater than 400 mw/cm².

For example, in the device for manufacturing an alignment film provided in one embodiment of the present disclosure, the illumination device forms an illumination pattern in a shape of a rectangular on the transmission device, and a length of the illumination pattern in a shape of a rectangular is from 1200 mm to 1400 mm in a direction of transmitting the substrate by the transmission device, a speed of transmitting the substrate by the transmission device is from 2200 mm/min to 4000 mm/min in the illumination region.

For example, in the device for manufacturing an alignment film provided in one embodiment of the present disclosure, at least three cleaning procedures are performed by the cleaning device.

### BRIEF DESCRIPTION OF THE DRAWINGS

In order to clearly illustrate the technical solution of the embodiments of the disclosure, the drawings of the embodiments will be briefly described in the following, it is obvious that the described drawings are only related to some embodiments of the disclosure and thus are not limitative of the disclosure.

FIG. 1 is a flow diagram of a manufacturing method of an alignment film provided by an embodiment of the present disclosure;

FIG. 2 is another flow diagram of a manufacturing method of an alignment film provided by an embodiment of the present disclosure;

FIG. 3 is a schematic diagram of a device for manufacturing an alignment film provided by an embodiment of the present disclosure; and

FIG. 4 is another schematic diagram of a device for manufacturing an alignment film provided by an embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at lease one. The terms “comprises,” “comprising,” “includes,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

At present, the general method for manufacturing an alignment film comprises: coating alignment liquid (PI solution) on a substrate (an array substrate or a color filter substrate) by a transfer plate (an ARP Plate), then a desired alignment film is formed on the substrate by an alignment process (such as a friction alignment process or an optical alignment process) and other processes. However, in the study, the inventors of the present application discover that, for a substrate having been shelved for a long time, the surface of the substrate has a lot of contaminants (such as organic impurities) which is difficult to be washed off. In a case that the alignment liquid is coated on the substrate after the cleaning process for the substrate has been completed, it is easy to cause coating defects. For example, for a color filter substrate, it is easy to cause bad adhesion between an overcoating (OC) layer on the surface of the color filter film substrate and the alignment liquid, in particular, in the case of using the alignment liquid with high viscosity, it is easier to cause coating defects.

At least one embodiment of the present disclosure provides a manufacturing method of an alignment film and a device for manufacturing an alignment film, and the manufacturing method of an alignment film comprises: irradiating a substrate with excimer ultraviolet (EUV) light; performing a cleaning process on the substrate which has been irradiated by the EUV light; and forming the alignment film on the substrate which has been subjected to the cleaning process. Thus, the manufacturing method of the alignment film can reduce the coating defects caused by coating the alignment liquid, and can improve the quality of the alignment film.

The manufacturing method of an alignment film and the device for manufacturing an alignment film provided by at least one embodiment of the present disclosure will be described in combination with the drawings.

### First Embodiment

The present embodiment provides a manufacturing method of an alignment film. FIG. 1 is a flow diagram of a manufacturing method of an alignment film, and the manufacturing method of the alignment film comprises the operations of S11 to S13.

Step S11: performing a cleaning process on a substrate;

Step S12: forming an alignment film on the substrate which has been subjected to the cleaning process;

Step S13: before performing a cleaning process on a substrate, the method further comprising: irradiating the substrate with excimer ultraviolet (EUV) light.

The manufacturing method of an alignment film provided by the present embodiment irradiates the substrate with excimer ultraviolet (EUV) light before performing the cleaning process on the substrate, and the organic impurities which are difficult to be washed off on the surface of the substrate can be decomposed by the irradiating of the excimer ultraviolet (EUV) light, and the decomposer remaining on the surface of the substrate and other easily cleanable impurities on the surface of the substrate can be removed by a subsequent cleaning process, thus, the contact angle between the alignment liquid and the surface of the substrate can be effectively reduced in the case of coating the alignment liquid, and the adhesion between the alignment liquid and the surface of the substrate can be effectively improved, thereby the coating defects can be effectively reduced.

For example, the manufacturing method of an alignment film provided by an example of the present embodiment further comprises: coating alignment liquid on the substrate which has been subjected to the cleaning process; and curing the alignment liquid coated on the substrate to form the alignment film.

For example, the substrate may be a color filter substrate or an array substrate, and the alignment liquid may be alignment liquid (such as polyimide) for a friction alignment process or alignment liquid for a optical alignment process.

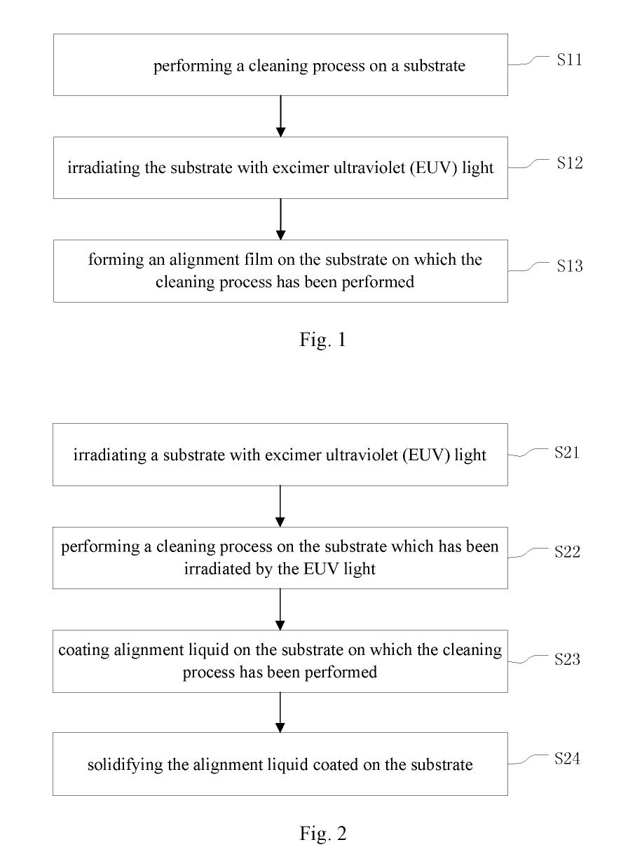

FIG. 2 is another flow diagram of a manufacturing method of an alignment film. As illustrated in FIG. 2, the manufacturing method of the alignment film comprises the operations of S21 to S24.

Step S21: irradiating a substrate with excimer ultraviolet (EUV) light, wherein for example, the substrate may be a color filter substrate, the amount of the EUV light irradiated on the substrate is from 8000 mj/cm² to 9000 mj/cm², for example, may be 8500 mj/cm² etc.;

Step S22: performing a cleaning process on the substrate which has been irradiated by the EUV light, wherein for example, the cleaning process comprises at least one cleaning procedure, and each cleaning procedure comprises: cleaning the substrate by a rolling brush; washing the substrate by gas-liquid mixture; and drying the substrate which has been cleaned, and drying the substrate comprises: blowing the surface of the substrate by an air knife firstly, and then irradiating the substrate with far infrared light;

Step S23: coating alignment liquid on the substrate which has been subjected to the cleaning process, wherein the alignment liquid may be alignment liquid (such as polyimide) for a fiction alignment process or alignment liquid for an optical alignment process;

Step S24: curing the alignment liquid coated on the substrate to form the alignment film, wherein an alignment process is then carried out to make the alignment film have a controlling force to the liquid crystal molecules.

In the above manufacturing method of an alignment film, irradiating a substrate with EUV light in step S21, and the decomposer remaining on the surface of the substrate and other easily cleanable impurities on the surface of the substrate can be removed by the cleaning process in step S22, thus, the contact angle between the alignment liquid and the surface of the substrate can be effectively reduced in step S23 of coating the alignment liquid, the adhesion between the alignment liquid and the surface of the substrate can be effectively improved, and further the coating defects can be effectively reduced. For example, in order to further improve the yield of coating, at least three cleaning procedures may be performed in the cleaning process; in this way, the defective rate of the coating process can be reduced to 0% to 0.5%.

For example, in the manufacturing method of an alignment film provided by an example of the present embodiment, before irradiating a substrate with excimer ultraviolet (EUV) light, the method further comprises: detecting standing time of the substrate, in a case that the standing time of the substrate is greater than or equal to a preset time period, the substrate is irradiated by the EUV light. Because contaminants (such as organic impurities) which are difficult to be washed off on the surface of the substrate are generally associated with the standing time of the substrate, the longer the substrate is shelved, the more the contaminants on the surface of the substrate. For example, in order to improve the production efficiency, before irradiating a substrate with excimer ultraviolet (EUV) light, the method further comprises: obtaining the standing time of the substrate; in a case that the standing time of the substrate is greater than or equal to a preset time period, the substrate is irradiated by the EUV light; the standing time of the substrate is the time interval from the production date to the current to make alignment film on the substrate; that is in the process of manufacturing the alignment film; it is possible to determine whether the substrate is illuminated by EUV or not according to the standing time of the substrate. For example, in a case that the standing time of the substrate is greater than or equal to six months, first irradiating the substrate with excimer ultraviolet (EUV) light, then performing a cleaning process on the substrate, coating alignment liquid on the substrate which has been subjected to the cleaning process, curing the alignment liquid coated on the substrate; in a case that the standing time of the substrate is less than six months, irradiating of the substrate with excimer ultraviolet (EUV) light may be omitted, performing a cleaning process on the substrate directly, and then performing a coating process and a curing process of the alignment liquid successively.

In the manufacturing method of an alignment film provided by an example of the present embodiment, in order to further reduce the coating defect, in the process of coating the alignment liquid, a high exposure APR Plate and a low viscosity APR Plate can be used.

### Second Embodiment

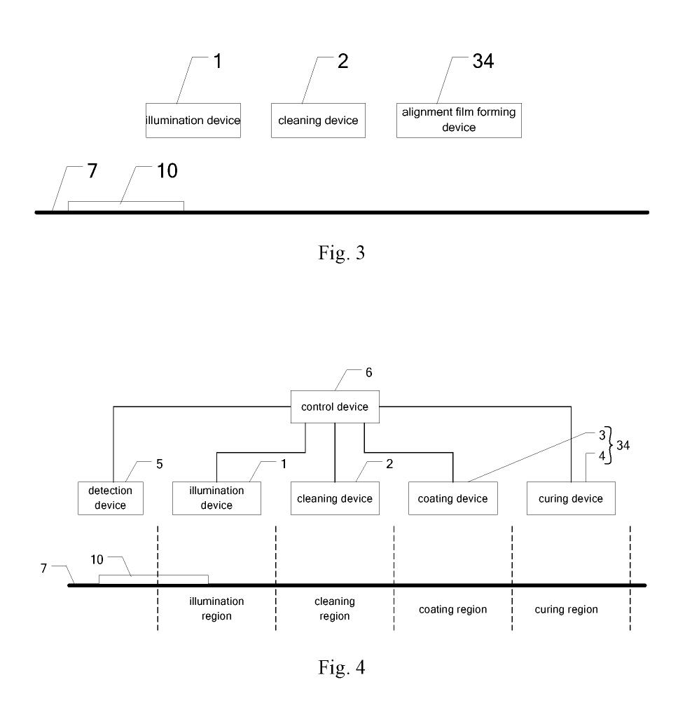

The present embodiment provides a device for manufacturing an alignment film, as illustrated in FIG. 3, the device comprises: an illumination device 1, the illumination device 1 being configured to perform EUV illumination on a substrate 10 to form an alignment film; a cleaning device 2, the cleaning device 2 being configured to perform a cleaning process on the substrate; and an alignment film forming device 34, the alignment film forming device 34 being configured to form the alignment film on the substrate 10.

In the device for manufacturing an alignment film provided by the present disclosure, a substrate is irradiated with excimer ultraviolet (EUV) light before performing a cleaning process on the substrate, and the organic impurities which are difficult to be washed off on the surface of the substrate can be decomposed by the irradiating of the excimer ultraviolet (EUV) light, and the decomposer remaining on the surface of the substrate and other easily cleanable impurities on the surface of the substrate can be removed by a subsequent cleaning process, thus, the contact angle between the alignment liquid and the surface of the substrate can be effectively reduced in the case of coating the alignment liquid, and the adhesion between the alignment liquid and the surface of the substrate can be effectively improved, thereby the coating defects can be effectively reduced.

In the device for manufacturing an alignment film provided by an example of the present embodiment, as illustrated in FIG. 4, the device for manufacturing an alignment film comprises: a cleaning device 2, the cleaning device 2 being configured to perform a cleaning process on the substrate 10; a coating device 3, the coating device 3 being configured to coat alignment liquid on the substrate 10 which has been cleaned by the cleaning process; a curing device 4, the curing device 4 being configured to cure the alignment liquid coated on the substrate 10; and an illumination device 1, the illumination device 1 being configured to performing EUV illumination on a substrate 10 before the cleaning process. That is to say, the device 34 for manufacturing an alignment film comprises a coating device 3 and a curing device 4 for forming an alignment film.

For example, the cleaning process comprises at least one cleaning procedure, and each cleaning procedure comprises: cleaning the substrate by a rolling brush; washing the substrate by gas-liquid mixture; and drying the substrate which has been cleaned, and drying the substrate comprises: blowing the surface of the substrate by an air knife firstly, and then irradiating the substrate with far infrared light.

For example, in the device for manufacturing an alignment film provided by an example of the present embodiment, the device for manufacturing an alignment film further comprises a detection device 5, a control device 6, and a transmission device 7. The detection device 5 is configured to detect the standing time of the substrate; in a case that the standing time of the substrate is greater than or equal to a preset time period, the control device 6 controls the illumination device 1 to irradiate the substrate by the EUV light; the transmission device 7 is configured to transmit the substrate to an illumination region, a cleaning region, a coating region and a curing region successively. It should be noted that, the illumination region is a region corresponding to the illumination device, the cleaning region is a region corresponding to the cleaning device, the coating region is a region corresponding to the coating device, and the curing region is a region corresponding to the curing device. The region corresponding to each device is the region of the device can be operated, for example, the region corresponding to the illumination device is a region where the illumination device can perform EUV illumination.

For example, the transmission device is a conveyor belt, of course, or other transmission devices can also be adopted, which is not limited in the embodiment of the present disclosure.

For example, in the device for manufacturing an alignment film provided by an example of the present embodiment, the control device 6 is in communication with the detection device 5, the transmission device 7, the illumination device 1, the cleaning device 2, the coating device 3, and the curing device 4 respectively. Therefore, in the case that the device is configured to make the alignment film on the substrate 10, the detection device 5 detects the standing time of the substrate 10 firstly, in a case that the standing time of the substrate 10 is greater than or equal to a preset time period and the transmission device 7 transmits the substrate 10 to the illumination region, the control device 6 is configured to control the illumination device 1 to irradiate the substrate 10 by the EUV light; in a case that the transmission device 7 transmits the substrate 10 to the cleaning region, the control device 6 is configured to control the cleaning device 2 to perform at least one cleaning procedure on the substrate 10; in a case that the transmission device 7 transmits the substrate 10 to the coating region, the control device 6 is configured to control the coating device 3 to coat alignment liquid on the substrate 10; in a case that the transmission device 7 transmits the substrate 10 to the curing region, the control device 6 is configured to control the curing device 4 to cure the alignment liquid on the substrate 10. In a case that the standing time of the substrate 10 is less than a preset time period, in a case that the transmission device 7 transmits the substrate 10 to the illumination region, the control device 6 is configured to control the illumination device 1 not to irradiate a substrate 10 with excimer ultraviolet (EUV) light, afterwards, the substrate 10 is transmitted to the cleaning region, the coating region, and the curing region successively by the transmission device 7, and in the corresponding regions, the control device 6 controls the cleaning device 2, the coating device 3 and the curing device 4 to perform a cleaning process, a coating process of alignment liquid, and a curing process on the substrate respectively.

For example, in a case that the substrate 10 is a color filter substrate, and the standing time of the substrate is greater than or equal to a preset time period, the substrate is irradiated by the EUV light, and the amount of the EUV light irradiated on the substrate is from 8000 mj/cm² to 9000 mj/cm², for example, may be 8500 mj/cm² etc. For example, in order to realize the amount of light, an irradiation power of the illumination device to the substrate is greater than 400 mw/cm²; the illumination device forms an illumination pattern in a shape of a rectangular on the transmission device, and a length of the illumination pattern in the shape of the rectangular is from 1200 mm to 1400 mm in a direction of transmitting the substrate by the transmission device, a speed of transmitting the substrate by the transmission device is from 2200 mm/min to 4000 mm/min in the illumination region.

For example, in order to further remove the contaminants on the surface of the substrate, and improve the yield of coating, in the cleaning region, at least three cleaning procedures may be performed in the cleaning process by the cleaning device.

What are described above is related to the illustrative embodiments of the disclosure only and not limitative to the scope of the disclosure; the scopes of the disclosure are defined by the accompanying claims.

The application claims priority to the Chinese patent application No. 201610188179.7, filed on Mar. 29, 2016, the entire disclosure of which is incorporated herein by reference as part of the present application.

1. A manufacturing method of an alignment film, comprising:
irradiating a substrate with excimer ultraviolet (EUV) light;
performing a cleaning process on the substrate which has been irradiated by the EUV light; and
forming the alignment film on the substrate which has been performed the cleaning process.

2. The manufacturing method of the alignment film according to claim 1, wherein the cleaning process comprises at least one cleaning procedure, and each cleaning procedure comprises:
cleaning the substrate by a rolling brush;
washing the substrate by gas-liquid mixture; and
drying the substrate.

3. The manufacturing method of the alignment film according to claim 2, wherein at least three cleaning procedures are performed in the cleaning process.

4. The manufacturing method of the alignment film according to claim 2, wherein drying the substrate comprises:
blowing the substrate by an air knife; and
irradiating the substrate with far infrared light.

5. The manufacturing method of the alignment film according to claim 1, wherein before irradiating the substrate with excimer ultraviolet (EUV) light, the method further comprises:
detecting standing time of the substrate, in a case that the standing time of the substrate is greater than or equal to a preset time period, the substrate is irradiated by the EUV light.

6. The manufacturing method of the alignment film according to claim 5, wherein the preset time period comprises six months.

7. The manufacturing method of the alignment film according to claim 1, wherein the amount of the EUV light is from 8000 mj/cm² to 9000 mj/cm².

8. The manufacturing method of the alignment film according to claim 1, further comprising:
coating alignment liquid on the substrate which has been subjected to the cleaning process; and
curing the alignment liquid coated on the substrate to form the alignment film.

9. The manufacturing method of the alignment film according to claim 8, wherein a material of the alignment liquid comprises polyimide.

10. The manufacturing method of the alignment film according to claim 1, wherein the substrate comprises a color filter substrate or an array substrate.

11. A device for manufacturing an alignment film, comprising:
an illumination device, configured to perform excimer ultraviolet (EUV) illumination on a substrate to form the alignment film;
a cleaning device, configured to perform a cleaning process on the substrate; and
an alignment film forming device, configured to form an alignment film on the substrate.

12. The device for manufacturing an alignment film according to claim 11, wherein the alignment film forming device comprises:
a coating device, configured to coat alignment liquid on the substrate which has been cleaned by the cleaning process; and
a curing device, configured to cure the alignment liquid coated on the substrate to form the alignment film.

13. The device for manufacturing an alignment film according to claim 12, wherein the cleaning process comprises at least one cleaning procedure, and each cleaning procedure comprises: cleaning the substrate by a rolling brush; washing the substrate by gas-liquid mixture; and drying the substrate.

14. The device for manufacturing an alignment film according to claim 12, further comprising:
a detection device, configured to detect standing time of the substrate; and
a control device, wherein the control device is configured to control the illumination device to irradiate the substrate by the EUV light in a case that the standing time of the substrate is greater than or equal to a preset time period.

15. The device for manufacturing an alignment film according to claim 14, further comprising:
a transmission device, configured to transmit the substrate to an illumination region corresponding to the illumination device, a cleaning region corresponding to the cleaning device, a coating region corresponding to the coating device, and a curing region corresponding to a curing device successively.

16. The device for manufacturing an alignment film according to claim 15, wherein the control device is in communication with the transmission device, the illumination device, the cleaning device, the coating device and the curing device respectively;
in a case that the standing time of the substrate is greater than or equal to the preset time period, after the transmission device transmits the substrate to the illumination region, the control device is configured to control illumination device to irradiate the substrate by the EUV light; after the transmission device transmits the substrate to the cleaning region, the control device is configured to control the cleaning device to perform at least one cleaning procedure on the substrate; after the transmission device transmits the substrate to the coating region, the control device is configured to control the coating device to coat alignment liquid on the substrate; after that the transmission device transmits the substrate to the curing region, the control device is configured to control the curing device to cure the alignment liquid on the substrate.

17. The device for manufacturing an alignment film according to claim 11, wherein an amount of the EUV light that the illumination device irradiates the substrate is from 8000 mj/cm² to 9000 mj/cm².

18. The device for manufacturing an alignment film according to claim 11, wherein an irradiation power of the illumination device to the substrate is greater than 400 mw/cm².

19. The device for manufacturing an alignment film according to claim 15, wherein the illumination device forms an illumination pattern in a shape of a rectangular on the transmission device, and a length of the illumination pattern in a shape of a rectangular is from 1200 mm to 1400 mm in a direction of transmitting the substrate by the transmission device, and a speed of transmitting the substrate by the transmission device is from 2200 mm/min to 4000 mm/min in the illumination region.

20. The device for manufacturing an alignment film according to claim 11, wherein at least three cleaning procedures are performed by the cleaning device.
